(19) United States
(12) Patent Application Publication
(10) Pub. No.: US 2012/0085801 A1
(43) Pub. Date: Apr. 12, 2012

(54) Notepad and Pencil on a Wristband

(76) Inventor: Patrick Ramon Carpenter PADILLA, Tucson, AZ (US)

(21) Appl. No.: 13/269,429

(22) Filed: Oct. 7, 2011

Related U.S. Application Data
(60) Provisional application No. 61/390,991, filed on Oct. 7, 2010.

(51) Int. Cl. B43K 29/12; B42D 5/00

(52) U.S. Cl. 224/576; 281/44

(57) ABSTRACT

The present invention is a useful tool for anyone that works with their hands but is also required to record information simultaneously. The present invention comprises essentially of a wristband, a writing plate, a writing utensil, a writing utensil holder, and a note pad, and two different attachment mechanisms. It is equipped to fit on the user's wrist for quick and effortless access to a writing pad and utensil.

The current application claims a priority to the U.S. Provisional Patent application Ser. No. 61/390,991 filed on Oct. 7, 2010.

### FIELD OF THE INVENTION

The present invention relates generally to a wristband with an attached notepad and pencil. Specifically, the present invention is an apparatus that combines a wristband, a notepad, and a pencil holder to give the user the convenience of having a note-taking mechanism readily accessible while working with one's hands.

### BACKGROUND OF THE INVENTION

Many jobs and tasks require taking notes in the middle of working, especially when working with one's hands. Also, a person may be required to perform tasks that involve moving back and forth from the job and taking notes. For example, interior designers, movers, construction workers, and a grocery shopper all have instances in which they may need to oscillate between completing a task and taking notes. Currently, a typical interior designer, who would need to measure lengths and widths of rooms and furniture, has to pull out a clipboard to record various dimensions immediately after a measurement is taken. The need to record a measured distance after each measurement is taken can result in an ample amount of time being spent on measurements alone rather than other equally important tasks. Similarly, movers and construction workers have to pull out a notepad to record measurements, place the notepad back into their pocket, and return to work. Again, this contributes to an unnecessary waste of valuable time. In the case of grocery shopping, the shopper has to stop the cart, pull out the shopping list, proceed to the desired aisle, and repeat this tedious cycle throughout the shopping trip. This repeated cycle of pulling out and storing a separate notepad, clipboard, or reference sheets is an inefficient process to accomplish a task that requires note-taking The present invention eliminates the need to go back and forth between notes and the task at hand and as a result, the present invention, saves a lot of the time that is often wasted volleying from taking notes to making measurements. It is an apparatus that combines the usefulness of a wristband, a notepad, and a pencil holder into one item. Instead of pulling out and storing the notes, the user is able to secure the notes onto his or her wrist for quick and open access. It is the objective of the present invention to provide the user freedom and mobility to complete a task while having the ability to quickly take notes if needed.

### BRIEF DESCRIPTION OF THE DRAWINGS

FIG. 1 is a perspective view of the present invention.

FIG. 2 is a front plan view of the present invention upon which detailed views are taken and shown in FIG. 3 and FIG. 4.

FIG. 3 is a detailed view of the note pad attachment mechanism.

FIG. 4 is a detailed view of the writing plate attachment mechanism.

FIG. 5 is top plan view of the present invention.

FIG. 6 is an exploded perspective view of the present invention.

FIG. 7 is an exploded back elevational view of the present invention.

### DETAIL DESCRIPTIONS OF THE INVENTION

All illustrations of the drawings are for the purpose of describing selected versions of the present invention and are not intended to limit the scope of the present invention.

The present invention, hereinafter referred to as Armor Band, is a product that is used to write down any kind of note or list, including, but not limited to, UPC numbers, shopping lists, rough framing or tile measurements, tailoring notes, or any type of construction notes. The present invention frees up the user's hands so they are able to work with boxes or other materials while being able to conveniently write down a note or measurement that can then easily be removed from the note pad and be placed wherever it will be put to use. Currently, there is no manageable manner of multitasking between note-taking and working with one's hands. Often the situation results in the user having to change between note-taking to working and back again to complete his or her specific task. This can become a burdensome because often times, this is being done in environments that are quite chaotic (i.e. a home makeover or a construction site), which is why quick access to a writing pad and a writing utensil is important. For example, a construction worker on a construction site is usually in a chaotic environment because of the various machines and other workers completing a variety of different tasks. It is much easier to keep track of important information with the present invention resting on the worker's wrist rather than having to search for a safe place to put his paper and writing utensil. Also, construction workers usually have a specific deadline in which they need to complete their tasks. Anything that can help the workers finish their jobs faster, like the present invention, is an improvement on their previous situation.

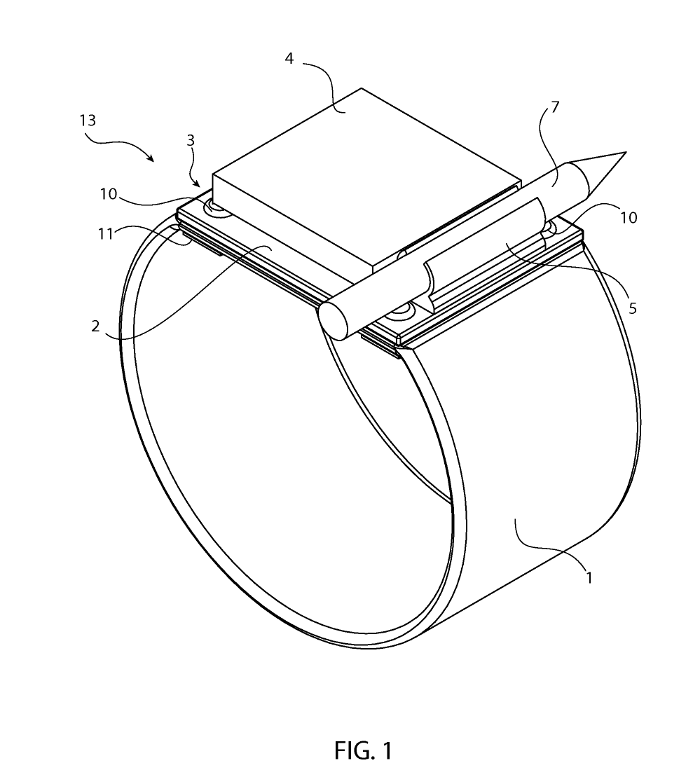

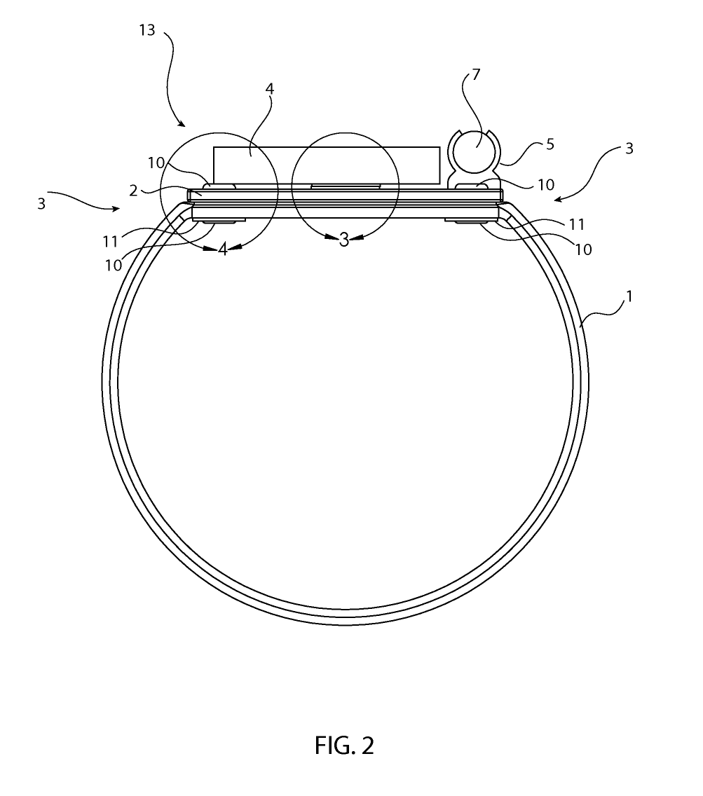

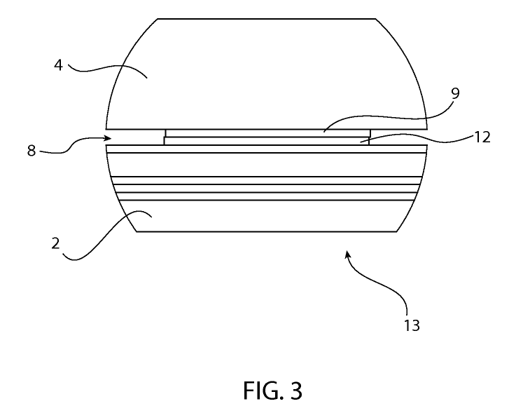

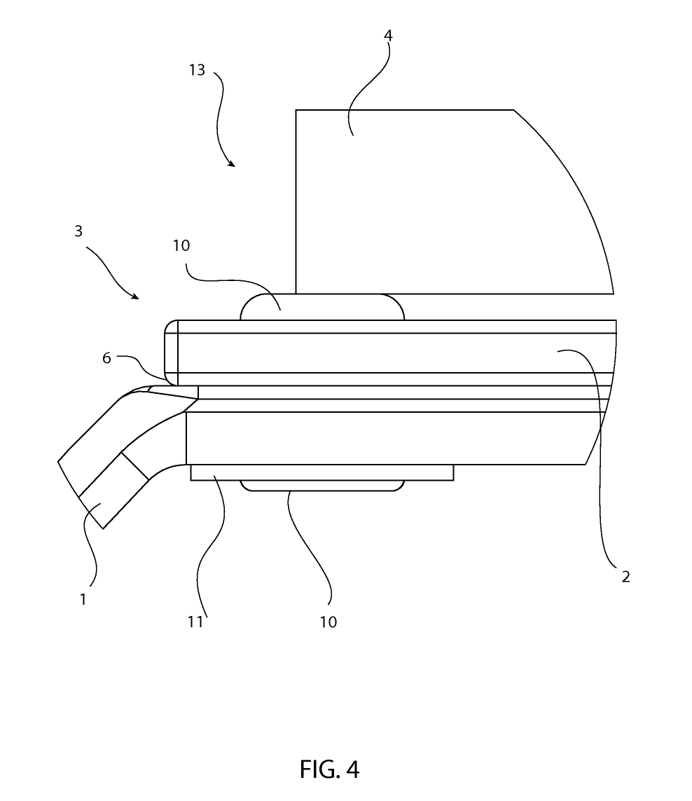

In reference to FIG. 1, FIG. 2, FIG. 3, and FIG. 4, the present invention consists of a wristband 1, a writing plate assembly 13, a note pad attachment mechanism 8, and a writing plate attachment mechanism 3. The wristband 1 can be of any material including, but not limited to, terrycloth, leather, plastic, and rubber. The main requirement for the material of the wristband is that it is a comfortable material that is suitable to be in contact with skin without causing irritation. The present invention allows free-handed access to a note pad 4 and writing utensil 7 because of its wristband 1. The wristband 1 remains on the user's wrist, much like an exercise sweatband that athletes often use. The wristband is able to travel with the user despite whatever task he or she is completing because of how closely and tightly it is fitted onto one's wrist. Similar to a sweatband, the wristband 1's elasticity allows the present invention to fit on any size wrist and remain there without falling off. The wristband 1 has the ability to stretch beyond its original shape, yet have the ability to compress back to its original shape. Consequently, the wristband 1 can be used multiple times without the worry of eventually losing its shape.

Referring to FIG. 1, FIG. 2, FIG. 3, FIG. 4, the next component of the present invention is the writing plate assembly 13. The writing plate assembly 13 comprises of a writing plate 2, a note pad 4, a writing utensil holder 5, and a writing utensil 7. In the present embodiment, the writing plate 2 is measured to be one eighth of an inch thick, two and a half inches wide, and three inches long, however the measurements of length, width, and thickness may vary. Also, the writing plate 2 can be made of Plexiglas, as shown in the current embodiment. The advantage of using Plexiglas is its shatter-resistant property. Being that the present invention rests on the body, using a material like glass would be dangerous because any damage to the apparatus could break the glass and wound an individual. Plexiglas has the additional benefit of looking similar to glass but lacks the dangers that arise from using glass as a surface material. However, other hard materials that can be used include, but are not limited to, wood, metal, or plastic. A hard material is needed to ensure that the user has a suitable surface upon which he or she can write on. A softer, bendable material would cause the note pad 4 to be difficult to write on because a softer material suggests a more pliable and unstable surface which requires more pressure to be placed upon it from the writing utensil 7. A stiff material requires less force from the user's writing utensil 7. Consequently, less pressure will be placed on the wrist, which is one of the more delicate areas of one's body. Also, since less force would be required to write on the note pad 4, it would alleviate a lot of pressure one can place on the writing hand. Another safety measure involves the design features of the writing plate 2 is a plurality of rounded edges 6 that ensures that the user is not injured by the writing plate 2 in the midst of working. Since the Armor Band is generally advertised to those who are often busy completing a variety of tasks, it would not be safe to have sharp edges because they can lead to unexpected injuries while in the rush of using the present invention. Since users are often on a deadline or have a time limit for completing these tasks, it is important that the present invention remain as hassle free as possible in order to contribute the convenience of the present invention. The rounded edges 6 are a safety measure that allows the Armor Band to be used a bit more aggressively if needed.

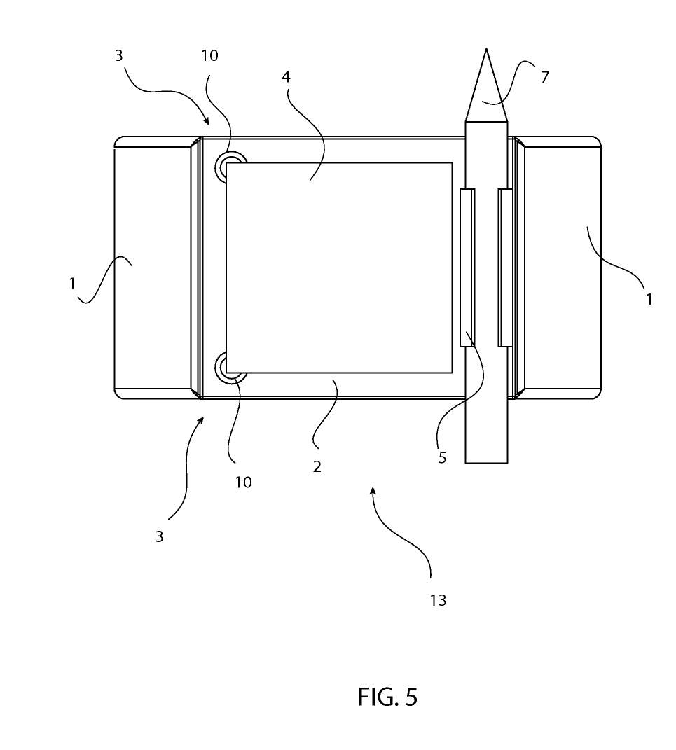

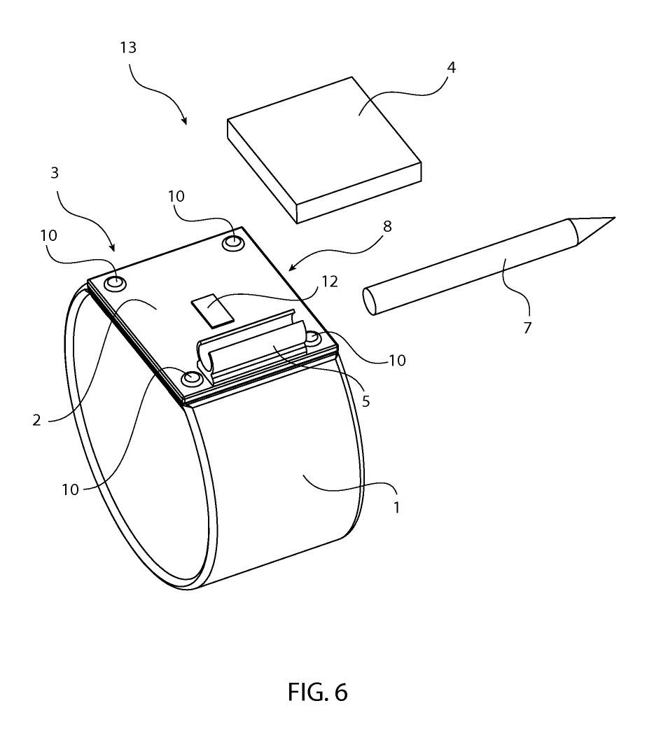

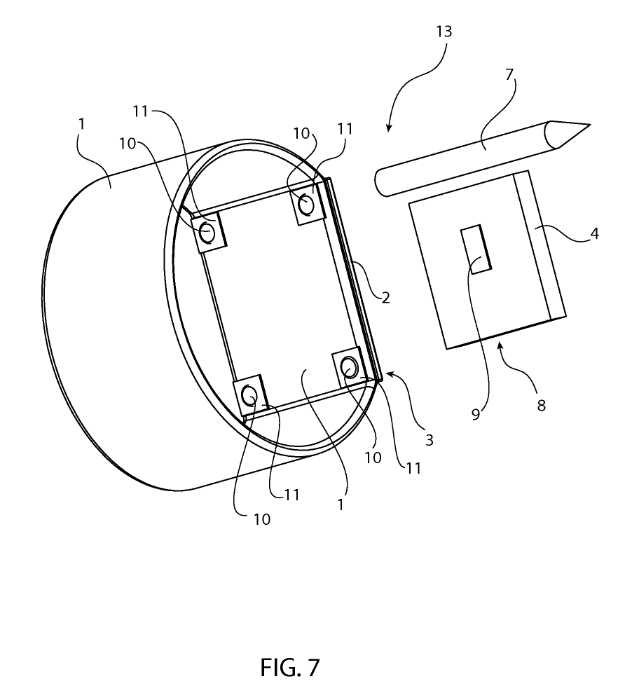

In reference to FIG. 2, FIG. 4, FIG. 5, FIG. 6, and FIG. 7, the writing plate attachment mechanism 3 ensures that the writing plate assembly 13, more specifically the writing plate 2, remains connected to the wristband 1. Presently, the attachment mechanism 3 comprises of a plurality of rivets 10 and corresponding nylon interfaces 11. For each rivet 10 that is inserted through the writing plate's 2 top surface there is an accompanying nylon interface 11 that is placed on the wristband's 1 underside. Each rivet 10 travels through the writing plate 2, the wristband 1, and finally through the nylon interface 11. Other variations of the present embodiment may include, but is not limited to, adhesives and Velcro straps in place of the rivets 10 to connect the writing plate 2 to the wristband 1. In the preferred embodiment, in order to keep the rivets 10 from tearing through the wristband 1, the nylon interface 11 (which, in the present embodiment is a half an inch by a half an inch) is placed between rivet's 10 head and the wristband 1. The nylon interface 11 is not only able to protect the wristband 1 material, but also the connection between the wristband 1 and the writing plate 2. It is important that the connection between the writing plate 2 and the wristband 1 be secure because these are the two main components of the present invention. Without a secure attachment, the writing plate 2 will be able to detach from the wristband 1 when not intending to do so. As a result, the present invention would not be readily available to use. Although the present embodiment makes use of the nylon interface 11, it may be replaced by materials such as, but not limited to, leather, plastic, and cloth to prevent the rivets 10 from tearing the wristband if rivets 10 are used. To ensure that the writing plate 2 does not fall off of the wristband 1 in the midst of working on a task, the attachment mechanism 3 must be well secured and connected to both components.

Referring to FIG. 5, FIG. 6 and FIG. 7, as a part of the writing plate assembly 13, the note pad 4 and writing utensil holder 5 are both connected to the writing plate 2. As with many of the features and components of the present invention, the note pad 4 is not restricted in its material or type of note pad. Besides an ordinary note pad, other types of paper that may be used include, but are not limited to, sticky notes, post-its, or notes that are re-positioned. Another feature that increases the convenience of the present invention is the writing utensil holder 5 that holds the writing utensil 7 in place when it is not in use. This ensures that there is always a writing utensil 7 available to use with the note pad 4. It would be an inconvenience to the user if he or she would need to find a writing utensil 7 every time he or she wished to use the present invention. The search for extra materials would cause more time to be spent on note-taking than needed. Having a designated area to put the writing utensil 7 decreases the chance of misplacing it. Often, users may place the writing utensil 7 on a nearby surface and later forget where they had placed it. The search for a writing utensil 7 would then extend the time needed to complete the task and as a result become an inconvenience. Currently, the writing utensil 7 used in the present embodiment is a golf pencil. However, the present invention is not limited to a golf pencil. Other writing utensils 7 can include, but are not limited to, a pen, a mechanical pencil, or a permanent marker. The writing utensil holder 5 can be made of any material that can bend so the holder 5 can accommodate different size writing utensils 7. A softer material, as opposed to the hard material used for the writing plate 2, will allow the holder 5 to fit the contours of the writing utensil 7 securely enough so there is no unintended movement of the writing utensil 7. In the present embodiment, the writing utensil holder 5 is made of magnetic material. However, other materials can be used for the writing utensil holder 5 including, but not limited to, plastic, a metal, or rubber. The advantage of the adjustable writing utensil holder 5 is that in the event that the writing utensil 7 is lost, another one can be added in its place. The writing utensil holder 5 can be attached to the writing plate 2 using any adhesive or epoxy. An alternative to gluing the writing utensil holder 5 to the writing plate 2, is to manufacture it with the writing plate 2, as one part. In some manufacturing processes, such as injection molding, the writing utensil holder 5 can be easily molded to the writing plate 2 so the writing utensil holder 5 is more securely attached to the writing plate 2. This process also increases the types of materials, specifically polymers and metals, which can be used to create the present invention. The placement of both the note pad 4 and writing utensil holder 5, as shown in the current embodiment, can be changed and adjusted as needed. The orientation of both of these components is not limited to the orientation as shown. The writing utensil holder 5 can be placed on a different side of the writing plate 2 and the note pad 4 can be repositioned in a different position as well.

In reference to FIG. 2, FIG. 3, FIG. 6 and FIG. 7, the other attachment mechanism used in the present invention is a note pad attachment mechanism 8. The note pad attachment 8 comprises of a male attachment 12 and a female attachment 9. If the male attachment 12 is on the note pad 4 then the female attachment 9 will be placed on the writing plate 2. However, the positions of both attachments can be changed. The male attachment 12 can also be placed on the writing plate 2 and as a result, the female attachment 9 can be placed on the note pad 4. The note pad attachment mechanism 8 ensures that the note pad 4 remains in its position on top of the writing plate 2, especially while the users hand is moving to complete the task. This is important because an objective of the present invention is to ensure that the user has access to the note-taking apparatus whenever needed. The note pad attachment mechanism 8 creates a secure, semi-permanent connection between the note pad 4 and the writing plate 2. Having a male part 12 and a female part 9 ensures that the two pieces will fit together securely and also be able to detach as well as reattach to each other. Another advantage of the note pad attachment mechanism 8 is that it allows the present invention to be reusable. When the note pad 4 is finished, it can simply be replaced with another note pad 4. Since the note pad 4 is detachable, the present invention is customizable to fit one's needs if the user decides to use his or her own note pad 4.

While the present invention can be an essential tool in an interior designer's or construction worker's tool box, it can also be used for other needs. For example, the Armor Band can also be used as a children's toy. Instead of having to tote around a drawing pad or other toys, a child can simply keep the present invention on his or her wrist and use it for whenever they choose to. Another possible use for the present invention is in a hospital, specifically for a nurse. During each shift, nurses are required to watch over multiple patients and therefore must remember a lot of information at one time. The Armor Band's is convenient because for the nurses because they can have a note pad handy without wasting time searching for a separate writing pad and writing utensil. Regardless of the user's intended purpose for the present invention, it is a convenient apparatus that is useful for quick note-taking or other forms of writing.

Although the invention has been explained in relation to its preferred embodiment, it is to be understood that many other possible modifications and variations can be made without departing from the spirit and scope of the invention as hereinafter claimed.

What is claimed is:

1. A note pad and pencil on a wristband comprises,
a wristband;
a writing plate assembly;
a note pad attachment mechanism;
a writing plate attachment mechanism;
the writing plate assembly being attached to the wristband;
the note pad attachment mechanism being attached to the writing plate assembly; and
the writing plate attachment mechanism connecting the writing plate assembly to the wristband.

2. The note pad and pencil on a wristband as claimed in claim 1 comprises,
the writing plate assembly comprises of a writing plate, a writing utensil holder, a writing utensil, and a note pad; and
the note pad attachment mechanism comprises of a male attachment and a female attachment.

3. The note pad and pencil on a wristband as claimed in claim 2 comprises,
the writing utensil holder being attached to the writing plate;
the writing utensil being placed within the writing utensil holder; and
the note pad attachment mechanism connecting the note pad to the writing plate.

4. The note pad and pencil on a wristband as claimed in claim 2 comprises,
the writing plate comprises of a plurality of rounded edges;
the male attachment being positioned on either the note pad or the writing plate; and
the female attachment being positioned on either the note pad or the writing plate.

5. A note pad and pencil on a wristband comprises,
a wristband;
a writing plate assembly;
a note pad attachment mechanism;
a writing plate attachment mechanism;
the writing plate assembly being attached to the wristband;
the note pad attachment mechanism being attached to the writing plate assembly;
the writing plate attachment mechanism connecting the writing plate assembly to the wristband;
the writing plate assembly comprises of a writing plate, a writing utensil holder, a writing utensil, and a note pad; and
the note pad attachment mechanism comprises of a male attachment and a female attachment.

6. The note pad and pencil on a wristband as claimed in claim 5 comprises,
the writing plate being connected to the wristband;
the writing utensil holder being attached to the writing plate;
the writing utensil being placed within the writing utensil holder;
the note pad attachment mechanism connecting the note pad to the writing plate;
the writing plate comprises of a plurality of rounded edges;
the male attachment being positioned on either the note pad or the writing plate; and
the female attachment being positioned on either the note pad or the writing plate.

7. A note pad and pencil on a wristband comprises,
a wristband;
a writing plate assembly;
a note pad attachment mechanism;
a writing plate attachment mechanism;
the writing plate assembly being attached to the wristband;
the note pad attachment mechanism being attached to the writing plate assembly;
the writing plate attachment mechanism connecting the writing plate assembly to the wristband;
the writing plate assembly comprises of a writing plate, a writing utensil holder, a writing utensil, and a note pad;
the note pad attachment mechanism comprises of a male attachment and a female attachment;
the writing plate being connected to the wristband;
the writing utensil holder being attached to the writing plate;
the writing utensil being placed within the writing utensil holder;
the note pad attachment mechanism connecting the note pad to the writing plate;
the writing plate comprises of a plurality of rounded edges;
the male attachment being positioned on either the note pad or the writing plate; and
the female attachment being positioned on either the note pad or the writing plate.
